(19) United States
(12) Patent Application Publication
(10) Pub. No.: US 2010/0059563 A1
(43) Pub. Date: Mar. 11, 2010

(54) BICYCLE RACK FOR MOTORCYCLES

(76) Inventor: Alan H. Hannum, Santa Rosa, CA (US)

Correspondence Address: STAINBROOK & STAINBROOK, LLP, 412 AVIATION BOULEVARD, SUITE H, SANTA ROSA, CA, 95403, US

(21) Appl. No.: 12/558,232

(22) Filed: Sep. 11, 2009

Related U.S. Application Data
(60) Provisional application No. 61/096,199, filed on Sep. 11, 2008.

(51) Int. Cl. B62J 11/00; B60R 9/10

(52) U.S. Cl. 224/413; 224/447; 224/459

(57) ABSTRACT

A bicycle rack for a motorcycle, including a first base member having an adjustable mounting assembly for securely mounting the base member to a motorcycle carrier rack positioned over the rear wheel of a motorcycle. The first base member is elongate and is positioned in a generally transverse orientation relative to the longitudinal axis of the motorcycle. At one end of the first base member there is disposed an adjustable platform for supporting or cradling a bicycle frame at or near the bicycle's bottom bracket. A second base member slidably inserts into the first base member and provides an extendable and retractable stem for adjusting the width of the bicycle rack to accommodate frames of varying sizes. The second base member includes a mounting structure for securing bicycle forks at the drop outs. The assembled and mounted rack secures a bicycle in a collapsed configuration in a transverse orientation on the motorcycle while also ensuring a generally balanced weight distribution of the bicycle over the motorcycle.

### CROSS REFERENCES TO RELATED APPLICATIONS

The present applications claims the benefit of U.S. Provisional Patent Application Ser. No. 61/096,199, filed Sep. 11, 2008 (Sep. 11, 2008).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to racks for holding articles, and more particularly to bicycle racks for using a motor vehicle to transport a bicycle, and still more particularly to a bicycle rack for use in transporting a bicycle with a motorcycle.

2. Discussion of Related Art Including Information Disclosed Under 37 CFR 1.97, 1.98

Using a motor vehicle to transport a bicycle is well known. Recreational cyclists routinely transport both road bikes and mountain bicycles via automobile by mounting and attaching the bicycles to a rack, which is in turn secured to the vehicle—generally to the roof, trunk area, or rear bumper. Cities are increasingly providing bicycle transport services on mass transportation vehicles, such as busses, trains, subways, and the like. Racks are typically installed at the front or rear of the vehicle, and riders place their bicycles in the rack for transport from station to station or stop to stop.

While the motive to provide a bicycle rack for a motorcycle might not be immediately apparent, it may be appreciated that the need for transporting a bicycle via motorcycle is precisely the need a car owner or mass transportation user has for transporting his or her bicycle. There truly is no difference. Either the distance to a bicycle trip starting point is some remove and too far for cycling, or there are time constraints, or the roads to a starting point are unsafe for bicycle or closed to bicycle traffic (freeways, for instance). And as individuals and societies move increasingly to more environmentally friendly transportation practices, motorcycles are increasingly becoming a primary mode of transportation. Accordingly, there is a need for a safe system for transporting a bicycle over long distances and at high speeds using a motorcycle.

Despite the need, to the knowledge of the inventor herein, at present there is only one commercially available bicycle rack adapted for use on a motorcycle. That rack is sold by Café Moto in Niwot, Colo. and goes by the proprietary name of “Johnny Rack.” As might be expected, the rack is attached to the motorcycle's rear carrier so that a bicycle is carried behind the rider when in use. However, the rack extends rearwardly from the driver's seat near the rear of the wheel of the motorcycle, and even well beyond the rear steering axis of the motorcycle. This places a large center of mass well out on a long moment arm extending from the rear of the motorcycle, and such a distribution of mass introduces significant degree of instability, thus danger, into ordinary turning maneuvers.

Thus, there exists a need for a bicycle rack for use on a motorcycle that provides a safe and economical means to transport a bicycle. The present invention addresses that need.

### BRIEF DESCRIPTION OF THE SEVERAL VIEWS OF THE DRAWINGS

The invention will be better understood and the objects of the invention will become apparent when consideration is given to the following detailed description thereof. Such description makes reference to the annexed drawings wherein:

FIG. 1A is a partially exploded upper right rear perspective view of the bicycle rack for motorcycles of the present invention, showing the apparatus in condition for attachment to a motorcycle rack;

FIG. 1B is the same view showing the apparatus assembled and in a fully collapsed configuration for transport;

FIG. 2 is a fully exploded upper right rear perspective showing the structural and functional elements thereof;

FIG. 3 is a rear view in elevation thereof;

FIG. 4A is a rear view in elevation showing the apparatus in a collapsed configuration, suitable for transporting the bicycle rack on a motorcycle without a bicycle mounted;

FIG. 4B is a rear view in elevation showing the inventive bicycle rack in a fully extended configuration, suitable for mounting a large frame bicycle; and

FIG. 4C shows the rack mounted on a motorcycle with a bicycle installed and secured in the rack.

### DETAILED DESCRIPTION OF THE INVENTION

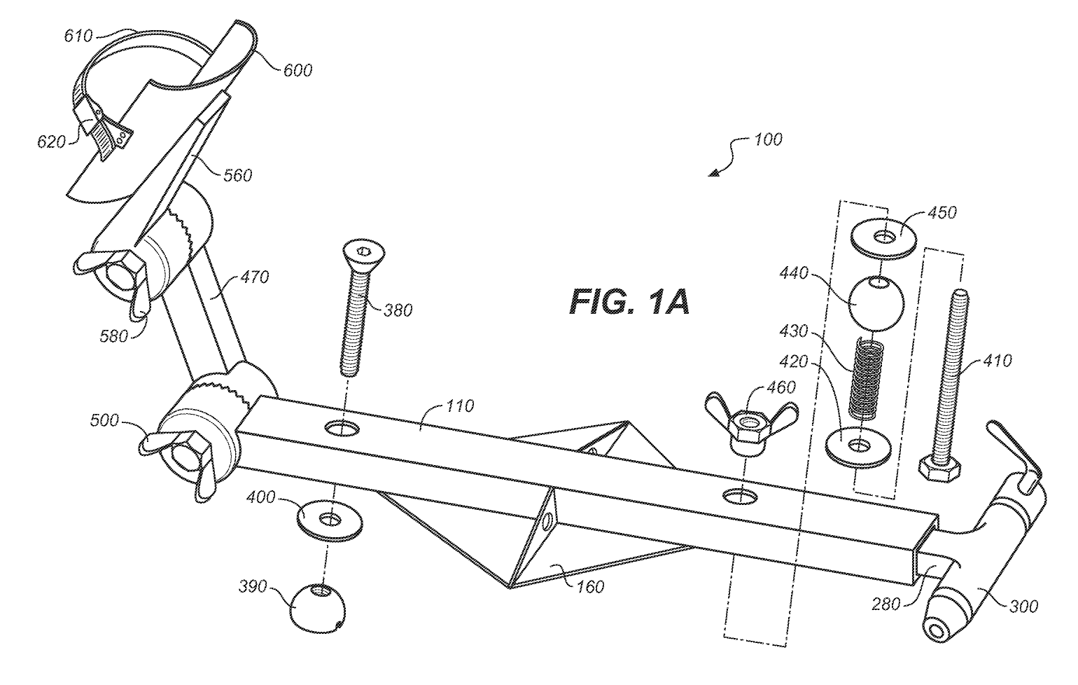

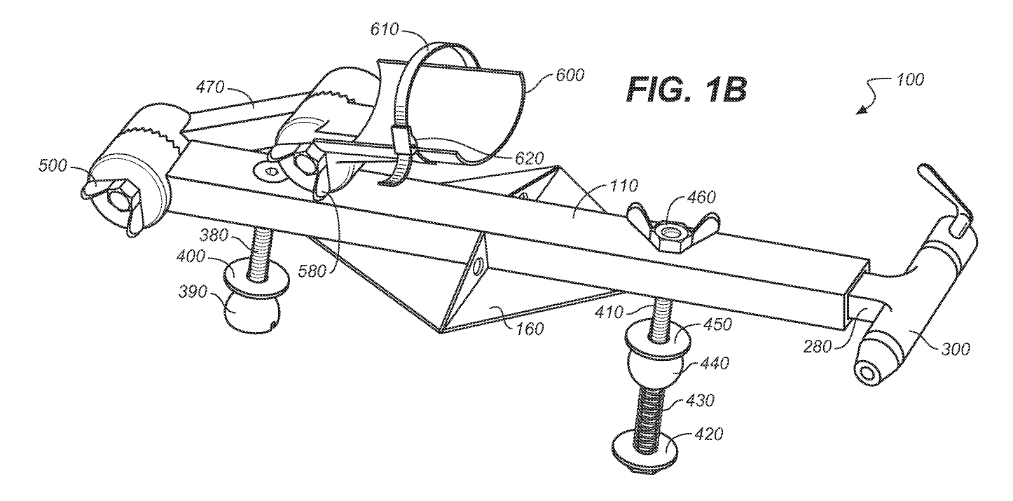

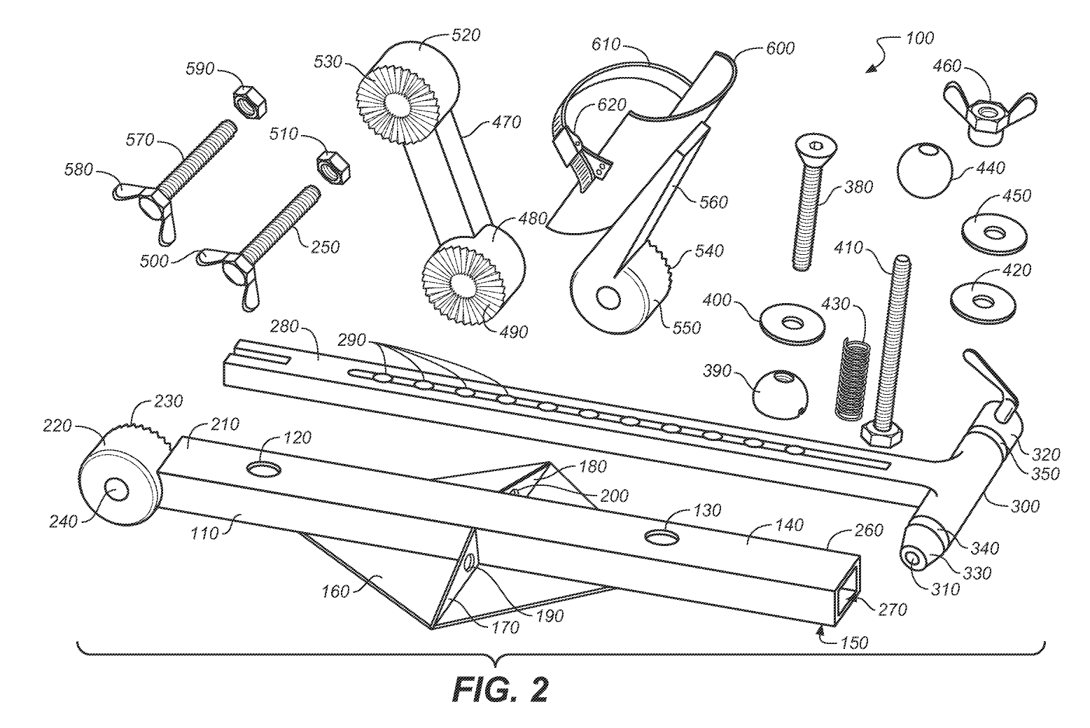

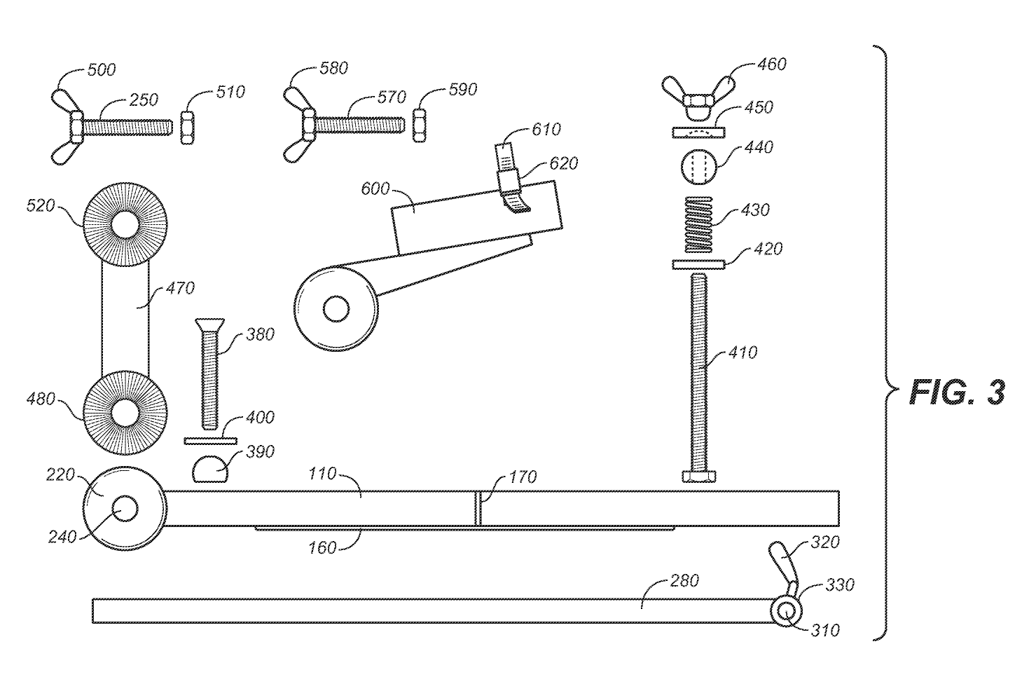

Referring to FIGS. 1 through 4C, wherein like reference numerals refer to common components in the various views, there is illustrated a new and improved bicycle rack for motorcycles, generally denominated 100. In the preferred embodiment, the inventive apparatus comprises a sleeve 110, preferably hollow square metal tubing or box channel, having two or more bolt holes 120, 130 passing through both the upper side 140 and lower side 150 of the sleeve and aligned to provide a through hole for the passage of a bolt. If box channel is used, the bolts extend downwardly through the slot, though it will be appreciate that the geometry and cross-sectional shape of the sleeve is not critical; many shapes will accommodate and make possible the above-described structural elements. A horizontal gusset plate 160 is welded to the bottom side of the sleeve, and first and second vertical gusset plates 170, 180, are disposed on the horizontal gusset plate, each providing increased strength and resistance to bending in the sleeve. The vertical gusset plates include tie down holes, 190, 200. A sufficiently sturdy sleeve may obviate the need for a gusset plate and call for the inclusion another kind of element to provide tie down points or holes, rather than the tie down holes shown as element 190. For instance, if sleeve 110 comprises a sufficiently sturdy metal or steel pipe, laterally extending welded posts having outboard eye holes, integral channels, or even knuckles may be employed to provide tie down points.

A first end 210 of the sleeve 110 includes an integral cylindrical knuckle 220 having teeth 230 on an inboard side, and a throughhole 240 for insertion of a threaded bolt 250. The second end 260 of the tubular sleeve presents an opening 270 to the sleeve's hollow interior, which is sized with tight clearances for the secure but slidable insertion of a stem 280 shaped to match the hollow interior.

The stem includes a row of through holes 290 spaced so as to provide a number of options in aligning a pair holes with the bolt holes 120, 130 in the sleeve, such that bolts (in bolt assemblies, described below) can be dropped through the sleeve and stem bolt holes. Accordingly, the stem is adjustably positioned within the sleeve for fitting the rack to bicycle frames of differing sizes. Once again, the geometry and cross-sectional shape of the stem is not critical and need only have an exterior shape closely matched in size and shape with the opening 270 and the entire hollow interior of sleeve 110.

The stem further includes a head tube 300, preferably cylindrical and having a bore to accept a skewer bolt 310 secured with a cam lever head 320 and a conical nut 330. The cam lever head and conical nut can be adjusted to create spacing 340, 350, from the head tube to accept the drop outs 360 disposed on the lower end of standard bicycle forks 370, in a manner well known in the art.

The bolt assemblies employed to secure the stem within the sleeve provide one of the novel features of the rack apparatus. Specifically, the bolt assemblies includes a first bolt assembly comprising a countersunk allen head bolt 380 inserted through the first bolt hole 120 and one of the stem through holes 290, and threadably secured by threaded spacer 390 having a hemispherical surface facing the sleeve. A washer 400 is disposed between the threaded spacer and the sleeve. Similarly, a second bolt assembly includes a bolt, preferably a carriage bolt 410, having, a lower washer 420, helical compression spring 430, ball spacer 440, and upper washer 450 are disposed over the bolt shank so as to be retained by the bolt head. The bolt is then inserted, preferably upwardly, through the second bolt hole 120 of the sleeve and another of the through holes 290 in the stem, such that it has an exposed end extended through the sleeve, which end is secured by a wing nut 460. The washers in each assembly swivel over the rounded crowns of the hemisphere and sphere so as to permit the bolts to urge the washers into a tight engagement with the structures of a motorcycle carrier rack 10 typical of those installed over the rear wheel of a motorcycle, thus firmly holding the bicycle rack onto the top of the carrier rack.

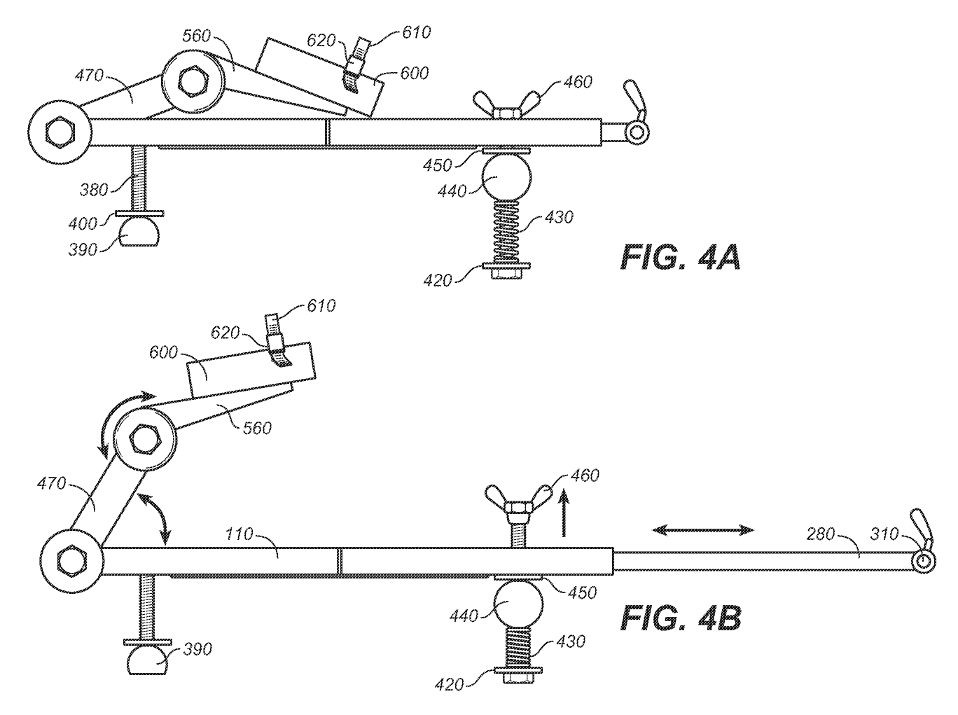

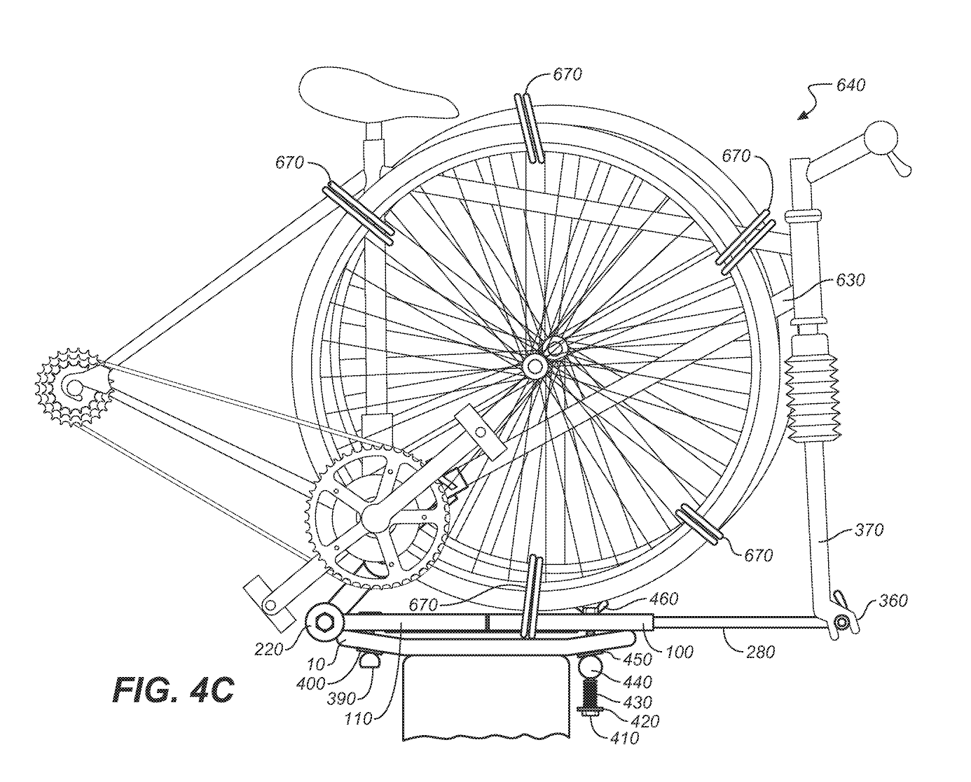

The apparatus next includes a lower arm 470 adjustably and rotatably connected to the sleeve knuckle 220 via a lower arm knuckle 480 having teeth 490 for selectively adjustable intermeshing engagement with the teeth 230 of the sleeve knuckle 220. Rapid adjustment and locking of the arm position is facilitated through the use of bolt 250, which has a wing head 500 and a nut 510. The arm further includes an upper arm knuckle 520 with inward facing teeth 530 that engage the teeth 540 of an upper arm knuckle 550 disposed on the lower end of an upper arm 560. The upper arm knuckle 520 and the upper knuckle of the lower arm are selectively released for adjustment and locked using a bolt 570 having a wing head 580 and a nut 590. Thus, the lower and upper arms are each selectively adjustable and lockable and can be deployed in a variety of configurations to fit a number of different bicycle geometries (see FIGS. 4B and 4C), or simply collapsed into a low profile for transport and storage (see FIG. 4A).

Next, the upper arm supports a frame cradle or tray 600 with a mechanism for strap down the down tube of a bicycle. Preferably that mechanism comprises a ribbed strap 610 operatively engaged with a ratcheting buckle 620, which is employed to ratchet the strap down and securely onto the down tube 630 of a bicycle 640. Numerous other tie down techniques and structures could be employed for securing the bicycle frame, but the ratcheting strap has proven especially sound.

To secure the bicycle rack of the present invention onto a motorcycle carrier rack 10, it is only necessary to remove bolts 380 and 410, position the rack over openings in the motorcycle carrier rack, extend stem 280 to the length suitable for the particular bicycle to be carried, and then to reinsert the bolts in the first and second bolt assemblies through the sleeve and stem, the bolt assemblies being positioned so as to bring washers 400 and 440 into engagement with the lower portion of the motorcycle carrier rack. The bolts are then suitably tightened.

When the rack is secure, a bicycle may be mounted on the rack. This entails removing both the front and rear wheels 650, 660 of the bicycle. The portion of the frame immediately superior to the bottom bracket is then placed onto the frame cradle 600 and the ribbed strap 610 is inserted through the ratcheting buckle 620 and ratcheted down tightly. The front fork drop outs 360 are placed in the spaces 340, 350 created by the skewer bolt 310 and the stem head 300 and the cam head 320 is tightened to secure the drop outs. The wheels are then placed within the center portion of the frame and fastened with tied downs 670. One ore more tie downs can be disposed through the holes 190, 200 in vertical gusset plates 170, 180. The ratcheting strap may be checked for sufficient tightness and further tightened, if necessary.

As will be appreciated, in this travel configuration, the center of mass of the bicycle frame is disposed slightly to the left side of the motorcycle, while the center of mass of the wheels is disposed slightly right of the motorcycle, thereby providing a generally balanced distribution of mass. In order to distribute the mass most evenly across the centerline of the motorcycle, the rack itself can easily be moved right and left and indexing marks made on the elements and the bicycle frame for future repeated uses for particular bicycles. This will economize in the time needed for both rack installation and bicycle mounting.

In its most essential aspect, therefore, the bicycle rack for motorcycles of the present invention comprises a mounting assembly for securing a first base member to a rear wheel motorcycle carrier rack in a generally transverse orientation relative to the longitudinal axis of the motorcycle.” As used herein, the term “transverse” means that the stem slides along a line that is transverse relative to the longitudinal axis of the motorcycle. In the above-described preferred embodiment, this comprises the sleeve 110 and the first and second bolt assemblies. A second base member is slidably connected to the first base member so as to provide an extendable and retractable arm for adjusting the width of the frame members to accommodate different sized bicycle frames. This is provided by the stem 280 which is slidably inserted into and then adjustably secured within the sleeve, and includes indexing and retention apparatus in the form of through holes that may be brought into alignment with the bolt holes in the sleeve, such that a bolt passed through the sleeve bolt holes and the stem through holes performs the dual function of setting the width of the bicycle rack and securing the rack to a motorcycle carrier rack. The first base member next includes an adjustable platform for supporting or cradling a bicycle frame at or near the bicycle's bottom bracket. In the preferred embodiment, this comprises the pivotally adjustable upper and lower arms, 560, 470, respectively, the tray 600 disposed on the upper arm, and the ratcheting strap and buckle 610, 620. The second base member includes a mounting structure for securing bicycle forks using the fork drop outs. In the preferred embodiment, this comprises the head tube 300, and the skewer bolt 310 and cam lever head 320 assembly. These are the most essential elements of the inventive apparatus as they comprise the structures that position and hold a bicycle in a collapsed configuration such that the longitudinal axis of the bicycle (as measured from the center of the front forks, through the bottom bracket to the center of the rear drop outs) is in a generally transverse orientation in relation to the longitudinal axis of the motorcycle. This also ensures a generally balanced weight distribution of the bicycle over the motorcycle to prevent control problems.

The above disclosure is sufficient to enable one of ordinary skill in the art to practice the invention, and provides the best mode of practicing the invention presently contemplated by the inventor. A full and complete disclosure of the preferred embodiments of this invention is provided herein, but this disclosure is not intended to limit the invention to the exact construction and operation shown and described. Various modifications, alternative geometries and constructions and equivalents will readily occur to those skilled in the art and may be employed, as suitable, without departing from the true spirit and scope of the invention. It will certainly be appreciated, for instance, that the cradle 600 and the pivotally connected upper and lower arms supporting it 460, 570, could be installed on the end of the stem 280, and the head tube 300 could be installed on the end of the sleeve 110. This alternative configuration is assumed to be encompassed by the claims.

Therefore, the above description and illustrations should not be construed as limiting the scope of the invention, which is defined by the appended claims.

What is claimed as invention is:

1. A motorcycle bicycle rack, comprising:
a first base member having a first and second end;
a mounting assembly for securing said first base member to a rear wheel motorcycle carrier rack in a generally transverse orientation relative to the longitudinal axis of the motorcycle;
a second base member having a first end and a second end, said first end slidably connected to said first base member;
indexing and retention apparatus for securing said second base member in a selectively extended or retracted position in relation to said first base member.
an adjustable frame support platform disposed on either said first end of said first base member or said second end of said second base member, said adjustable frame support platform for cradling and securing a bicycle frame at or near the bicycle bottom bracket; and
a fork mounting structure for securing bicycle forks using the fork drop outs, said fork mounting structure disposed on either said first end of said first base member or said second end of said second base member.

2. The apparatus of claim 1, wherein said first base member comprises a hollow sleeve and said mounting assembly comprises first and second bolt assemblies.

3. The apparatus of claim 1, wherein said first base member is a hollow sleeve having one open end, and wherein said second base member comprises a stem, wherein said first end of said stem is slidably inserted into the open end of said first base member and then adjustably secured within the sleeve so as to provide an extendable and retractable arm for adjusting the width of the frame members to accommodate different sized bicycle frames.

4. The apparatus of claim 1, wherein said adjustable frame support platform comprises:
at least one arm having an upper end and a lower end, said lower end pivotally connected to said first end of said first base member;
a tray pivotally connected to said upper end of said at least one arm; and
a retaining assembly for capturing and retaining the bicycle frame in said tray.

5. The apparatus of claim 4, wherein said retaining assembly comprises a ratcheting strap and ratcheting buckle attached to said tray.

6. The apparatus of claim 4, wherein said adjustable frame support platform includes:
a lower arm having an upper end and a lower end, said lower end of said lower arm pivotally connected to said first end of said first base member;
an upper arm having an upper end and a lower end, said lower end of said upper arm pivotally connected to said upper end of said lower arm;
a tray pivotally connected to said upper end of said upper arm; and
a retaining assembly for capturing and retaining the bicycle frame in said tray.

7. The apparatus of claim 6, wherein said retaining assembly comprises a ratcheting strap and ratcheting buckle attached to said tray.

8. The apparatus of claim 4, wherein said fork mounting structure comprises a head tube, and a skewer bolt disposed through said head tube and having a cam lever head.

9. The apparatus of claim 2, wherein said sleeve includes first and second bolt holes, said stem includes a plurality of stem through holes, and said mounting assembly comprises:
a first bolt assembly including a first bolt inserted through said first bolt hole and one of said plurality of stem through holes, a washer disposed over said shank of said first bolt, and a threaded spacer having a hemispherical surface facing said sleeve;
a second bolt assembly including a second bolt, a lower washer, a spring, a ball spacer, and an upper washer disposed over the shank of said second bolt so as to be retained by the bolt head, whereby when said second bolt is inserted through said second bolt hole in said sleeve and one of said plurality of through holes in said stem, said second bolt has an exposed end extending through said the sleeve secured by a wing nut;
wherein said washers in said first and second mounting assemblies swivel over the surfaces of said threaded spacer and said ball spacer so as to permit said first and second bolts to urge said washers into a tight engagement with the structures of a motorcycle carrier rack.

10. A method of transporting a bicycle on a motorcycle, comprising the steps of:
(a) providing a bicycle rack that includes a first base member having a first and second end, a mounting assembly for securing the first base member to a motorcycle carrier rack in a generally transverse orientation relative to the longitudinal axis of the motorcycle, a second base member having a first end and a second end, the first end slidably connected to the first base member, indexing and retention apparatus for securing the second base member in a selectively extended or retracted position in relation to the first base member, an adjustable frame support platform disposed on either the first end of the first base member or the second end of the second base member, the adjustable frame support platform for cradling and securing a bicycle frame at or near the bicycle bottom bracket, and a fork mounting structure for securing bicycle forks using the fork drop outs, the fork mounting structure disposed on either the first end of the first base member or the second end of the second base member and having means for clamping the bicycle fork drop outs;
(b) extending the stem to the length suitable for the particular bicycle to be transported;
(c) mounting the bicycle rack on the motorcycle carrier rack in a generally transverse orientation in relation to the longitudinal axis of the motorcycle;
(d) removing both the front and rear wheels of the bicycle to be transported;
(e) placing a portion of the bicycle frame onto the adjustable frame support platform;
(f) securing the frame in the adjustable support platform with a strap;
(g) clamping the bicycle front fork drop outs in the fork mounting structure; and
(h) placing the wheels within the center portion of the frame and fastening each with tie downs;
whereby the longitudinal axis of the bicycle is in a generally transverse orientation in relation to the longitudinal axis of the motorcycle and the mass of the bicycle is generally evenly distributed over the motorcycle.
